(19) United States
(12) Patent Application Publication
(10) Pub. No.: US 2017/0236167 A1
(43) Pub. Date: Aug. 17, 2017

(54) MANAGEMENT OF AN ADVERTISING EXCHANGE USING EMAIL DATA

(71) Applicant: Zeta Interactive Corp., New York, NY (US)

(72) Inventors: Dex Bindra, Jersey City, NJ (US); Jeffrey S. Nimeroff, Medford, NJ (US); Thomas Walsh, Brooklyn, NY (US)

(21) Appl. No.: 15/430,156

(22) Filed: Feb. 10, 2017

Related U.S. Application Data
(60) Provisional application No. 62/294,709, filed on Feb. 12, 2016.

(51) Int. Cl. G06Q 30/02; G06F 17/30

(52) U.S. Cl. CPC G06Q 30/0277; G06F 17/30864

(57) ABSTRACT

Methods, systems, and media for management of an advertising exchange using email data are disclosed. In one example, a method of managing an advertising exchange using email data comprises receiving one or more inputs of audience data from one or more publishers, transforming the one or more inputs into information in a unified customer database, receiving a query from a front end query tool, accessing information in the unified customer database responsive to the query, and providing the responsive information to the front end query tool.

### CLAIM OF PRIORITY

This patent application claims the benefit of priority, under 35 U.S.C. Section 119(e), to Bindra et al, U.S. Provisional Patent Application Serial No. 62/294,709, entitled “Management Of An Advertising Exchange Using Email Data,” filed on Feb. 12, 2016 (Attorney Docket No. 4525.006PRV), which is hereby incorporated by reference herein in its entirety.

### TECHNICAL FIELD

The present disclosure relates to systems and methods for managing an advertising exchange using email data, and, more specifically, to systems and methods for managing access and purchase of advertising inventory using email data.

### BACKGROUND

Targeted marketing is a commonly used tool for improving return on investment for advertising expenditures. In general, the more accurate the targeting is to consumers, the more benefit is received from the advertising campaign.

Currently, there are no existing systems that utilize email data to operate a publisher advertiser exchange. In existing systems, advertisers usually must work directly with sets of independent publishers. This can involve negotiating multiple rates while conforming to multiple standards. Alternatively, the advertisers must work through an agency, which may not provide transparency or economies of scale.

Needs exist for technically improved systems and methods for marketing campaigns, and more specifically, for improved data accuracy in such methods.

### BRIEF DESCRIPTION OF THE DRAWINGS

Some embodiments of the present disclosure are illustrated by way of example and not limitation in the figures of the accompanying drawings, in which like reference numbers indicate similar elements.

FIG. 1 is a block diagram illustrating a networked system for management of an advertising exchange using email data, according to an example embodiment.

FIG. 2 is a block diagram showing architectural details of the networked system, according to some example embodiments.

FIG. 3 is a block diagram illustrating a representative software architecture, which may be used in conjunction with various hardware architectures herein described.

FIG. 4 is a block diagram illustrating components of a machine, according to some example embodiments, able to read instructions from a machine-readable medium (e.g., a machine-readable storage medium) and perform any one or more of the methodologies discussed herein.

FIG. 5 is a block diagram illustrating another exemplary system for management of an advertising exchange using email data.

FIG. 6 is a block diagram illustrating an exemplary system for computational aspects of an advertising exchange using email data.

FIG. 7 is an exemplary flow diagram for management of an advertising exchange using email data.

FIG. 8 is an exemplary flow diagram for management of an advertising exchange using email data.

FIG. 9 is a flow chart depicting some operations in a method of management of an advertising exchange using email data, in accordance with an example embodiment.

FIG. 10 is a flow chart depicting some operations in another method of management of an advertising exchange using email data, in accordance with an example embodiment.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter can be practiced without these, specific details. In general, well-known instruction instances, protocols, structures, and techniques have not been shown in detail. The present disclosure provides technical solutions in methods for management of an advertising exchange using email data. Systems, methods, and architectures for the optimization of management of an advertising exchange using email data are disclosed herein.

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2016, Zeta Interactive Corp., All Rights Reserved.

Systems and methods are described for using various tools and procedures for management of an advertising exchange using email data. In certain embodiments, the tools and procedures may be used in conjunction with improved performance of targeted advertising campaigns in the email channel. The examples described herein relate to email channels for illustrative purposes only. The systems and methods described herein may be used for many different channels, industries, and purposes, including any type of marketing campaigns and/or other industries completely. In particular, the systems and methods may be used for any industry or purpose where targeted marketing is needed. For example, email data could be used to operate an exchange for SMS marketing or social media marketing. For multi-step processes or methods, steps may be performed by one or more different parties, servers, processors, etc.

Certain embodiments may provide systems and methods for targeted advertising. Systems and methods may aggregate email inventory from multiple publishers across demographic, psychographic, implicit, explicit, imputed, and computed attributes. The aggregated email inventory may be visible to advertisers. This may facilitate purchase of data for the purpose of targeting and sending third-party dedicated emails.

Certain embodiments may allow advertisers to easily access and purchase email data enabling them to optimize yield across dedicated email audiences. In addition, publishers may be able to monetize inventory at a premium and more often than with existing systems because the inventory is available to multiple advertisers and aggregated in a marketplace.

An “EMAIL CHANNEL” in this context may be any communication sent electronically to an electronic address, i.e., sent via email. In certain embodiments, an email channel may refer to sending of third-party advertisements through email.

In general, “INVENTORY” in this context may be a term for a unit of advertising space, such as a magazine page, television airtime, direct mail message, email messages, text messages, telephone calls, etc. Advertising inventory may be advertisements a publisher has available to sell to an advertiser. In certain embodiments, advertising inventory may refer to a number of email advertisements being bought and/or sold. The terms INVENTORY and ADVERTISING INVENTORY may be used interchangeably. For email marketing campaigns, advertising inventory is typically an email message.

A “PUBLISHER” in this context may be an entity that sells advertising inventory, such as those produced by the systems and methods herein, to their email subscriber database. An advertiser may be a buyer of publisher email inventory. Examples of advertisers may include various retailers. A marketplace may allow advertisers and publishers to buy and sell advertising inventory. Marketplaces, also called exchanges or networks, may be used to sell display, video, and mobile inventory. In certain embodiments, a marketplace may be an email exchange/email marketplace. An email exchange may be a type of marketplace that facilitates buying and/or selling of inventory between advertisers and publishers. This inventory may be characterized based on customer attributes used in marketing campaigns. Therefore, an email exchange may have inventory that can be queried by each advertiser. This may increase efficiency of advertisers when purchasing inventory. A private network may be a marketplace that has more control and requirements for participation by both advertisers and publishers.

An “INDIVIDUAL RECORD” or “PROSPECT” in this context may be at least one identifier of a target. In certain embodiments, the individual record/prospect may be identified by a record identification mechanism, such as a specific email address (individual or household) that receives an email message.

An “AUDIENCE” in this context may be a group of records, which may be purchased as inventory. In certain embodiments, an audience may be a group of records selected from publisher databases of available records. The subset of selected records may adhere to a predetermined set of criteria, such as common age range, common shopping habits, and/or similar lifestyle situation (i.e., stay-at-home mother). Advertisers generally select the predetermined set of criteria when they are making an inventory purchase.

“CARRIER SIGNAL” in this context in this context refers to any intangible medium that is capable of storing, encoding, or carrying instructions for execution by a machine, and includes digital or analog communications signals or other intangible media to facilitate communication of such instructions. Instructions may be transmitted or received over a network using a transmission medium via a network interface device and using any one of a number of well-known transfer protocols.

“CLIENT DEVICE” in this context refers to any machine that interfaces with a communications network to obtain resources from one or more server systems or other client devices. A client device may be, but is not limited to, a mobile phone, desktop computer, laptop, portable digital assistant (PDA), smart phone, tablet, ultra-book, netbook, laptop, multi-processor system, microprocessor-based or programmable consumer electronics system, game console, set-top box, or any other communication device that a user may use to access a network.

“COMMUNICATIONS NETWORK” in this context refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling of the client device to the network may be a Code Division Multiple Access (CDMA) connection, a Global System for Mobile communications (GSM) connection, or another type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“COMPONENT” in this context refers to a device, a physical entity, or logic having boundaries defined by function or subroutine calls, branch points, application program interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components.

A “HARDWARE COMPONENT” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors.

It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“MACHINE-READABLE MEDIUM” in this context refers to a component, a device, or other tangible media able to store instructions and data temporarily or permanently, and may include, but not be limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“PROCESSOR” in this context refers to any circuit virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), or any combination thereof. A processor may further be a multi-core processor having two or more independent processors (sometimes referred to as “cores”) that may execute instructions contemporaneously.

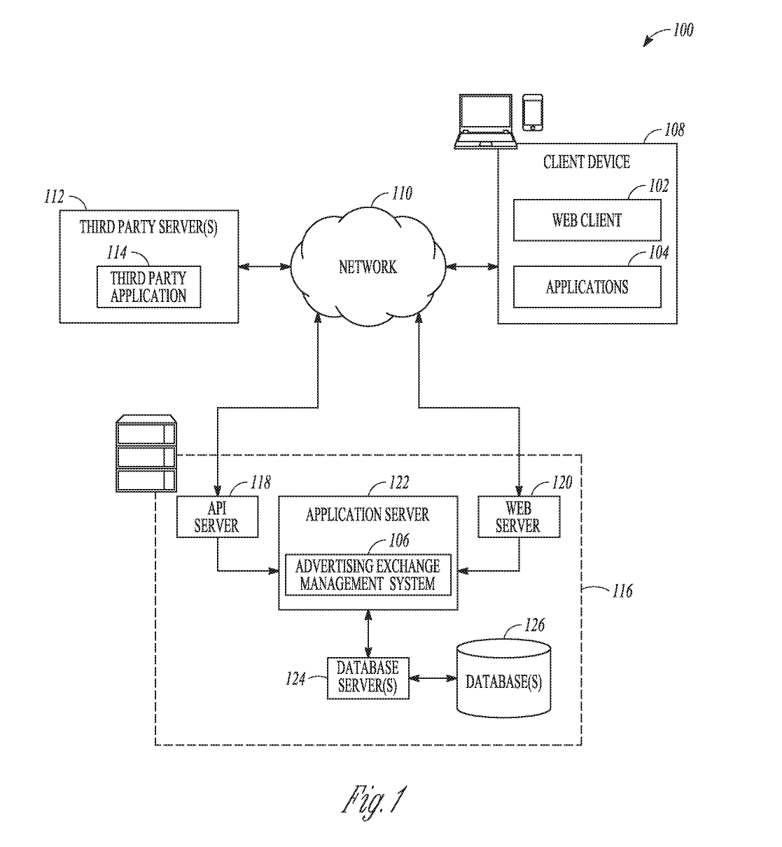

With reference to FIG. 1, an example embodiment of a high-level SaaS network architecture 100 is shown. A networked system 116 provides server-side functionality via a network 110 (e.g., the Internet or a WAN) to a client device 108. A web client 102 and a programmatic client, n the example form of an application 104, are hosted and execute on the client device 108. The networked system 116 includes an application server 122, which in turn hosts an advertising exchange management system 106 for management of an advertising exchange using email data according to one embodiment. The advertising exchange management system 106 provides a number of functions and services to the application 104 that accesses the networked system 116. The application 104 also provides a number of interfaces described herein, which present output of tracking and analysis operations to a user of the client device 108.

The client device 108 enables a user to access and interact with the networked system 116. For instance, the user provides input (e.g., touch screen input or alphanumeric input) to the client device 108, and the input is communicated to the networked system 116 via the network 110. In this instance, the networked system 116, in response to receiving the input from the user, communicates information back to the client device 108 via the network 110 to be presented to the user.

An Application Program Interface (API) server 118 and a web server 120 are coupled, and provide programmatic and web interfaces respectively, to the application server 122. The application server 122 hosts the advertising exchange management system 106, which includes components or applications. The application server 122 is, in turn, shown to be coupled to a database server 124 that facilitates access to information storage repositories (e.g., a database 126). In an example embodiment, the database 126 includes storage devices that store information accessed and generated by the advertising exchange management system 106.

Additionally, a third-party application 114, executing on a third-party server(s) 112, is shown as having programmatic access to the networked system 116 via the programmatic interface provided by the API server 118. For example, the third-party application 114, using information retrieved from the networked system 116, may support one or more features or functions on a website hosted by a third party.

Turning now specifically to the applications hosted by the client device 108, the web client 102 may access the various systems (e.g., advertising exchange management system 106) via the web interface supported by the web server 120. Similarly, the application 104 (e.g., an “app”) accesses the various services and functions provided by the advertising exchange management system 106 via the programmatic interface provided by the API server 118. The application 104 may be, for example, an “app” executing on the client device 108, such as an IOS™ or ANDROID™ OS application to enable a user to access and input data on the networked system 116 in an offline manner, and to perform batch-mode communications between the application 104 and the networked system 116.

Further, while the SaaS network architecture 100 shown in FIG. 1 employs a client-server architecture, the present inventive subject matter is of course not limited to such an architecture, and could equally well find application in a distributed, or peer-to-peer, architecture system, for example. The advertising exchange management system 106 could also be implemented as a standalone software program, which does not necessarily have networking capabilities.

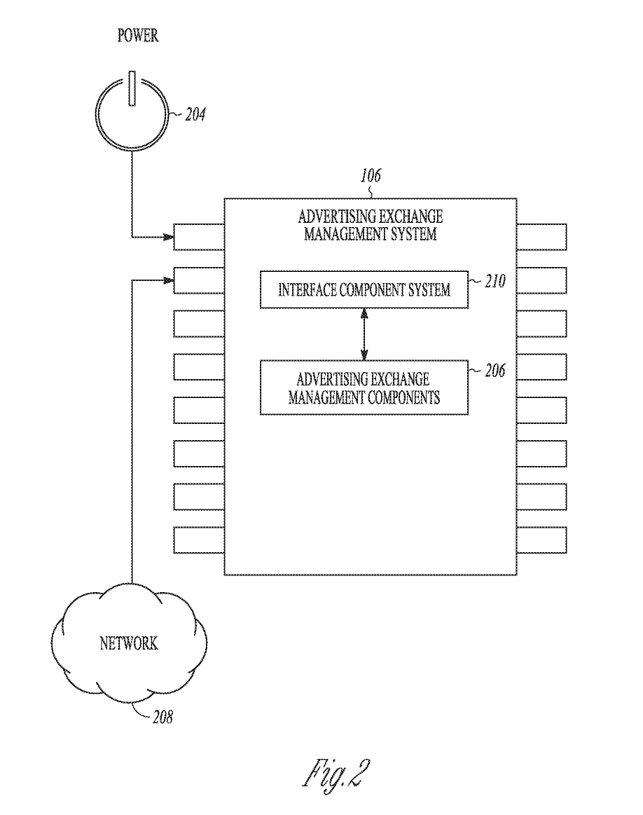

FIG. 2 is a block diagram showing architectural details of an advertising exchange management system 106, according to some example embodiments. Specifically, the advertising exchange management system 106 is shown to include an interface component 210 by which the advertising exchange management system 106 communicates (e.g., over a network 208) with other systems within the SaaS network architecture 100.

The interface component 210 is collectively coupled to one or more advertising exchange management components 206 that operate to provide specific aspects of management of an advertising exchange using email data, in accordance with the methods described further below with reference to the accompanying drawings.

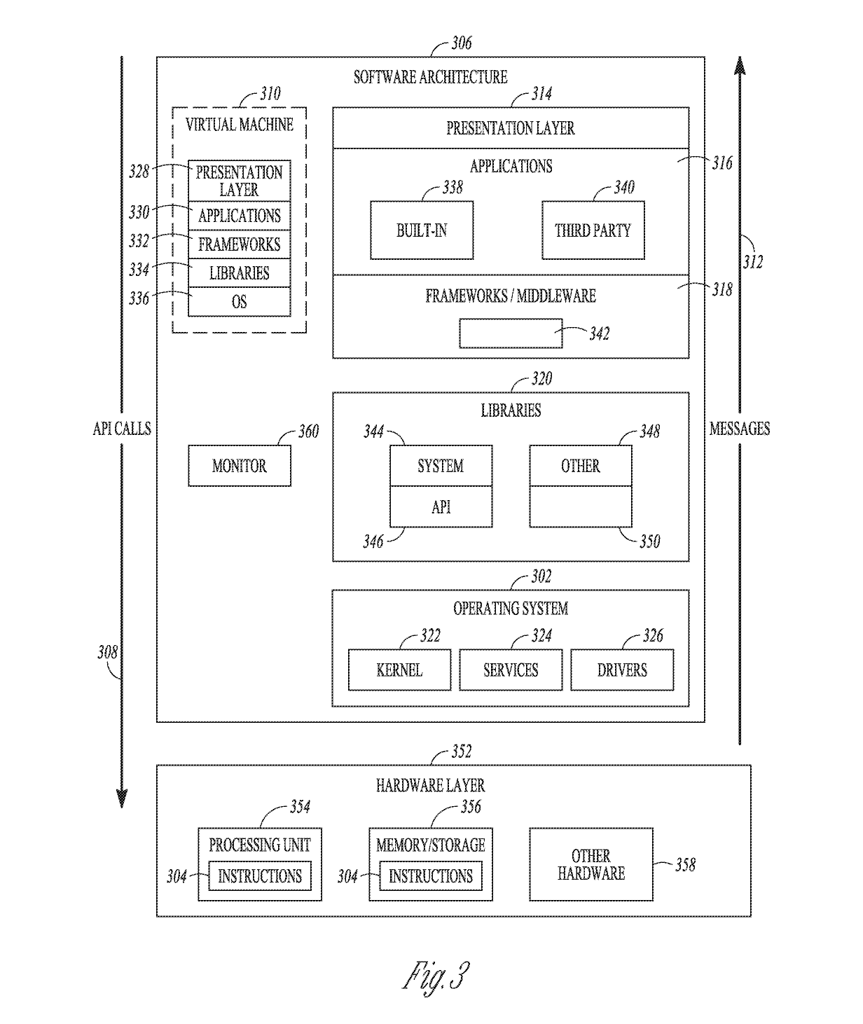

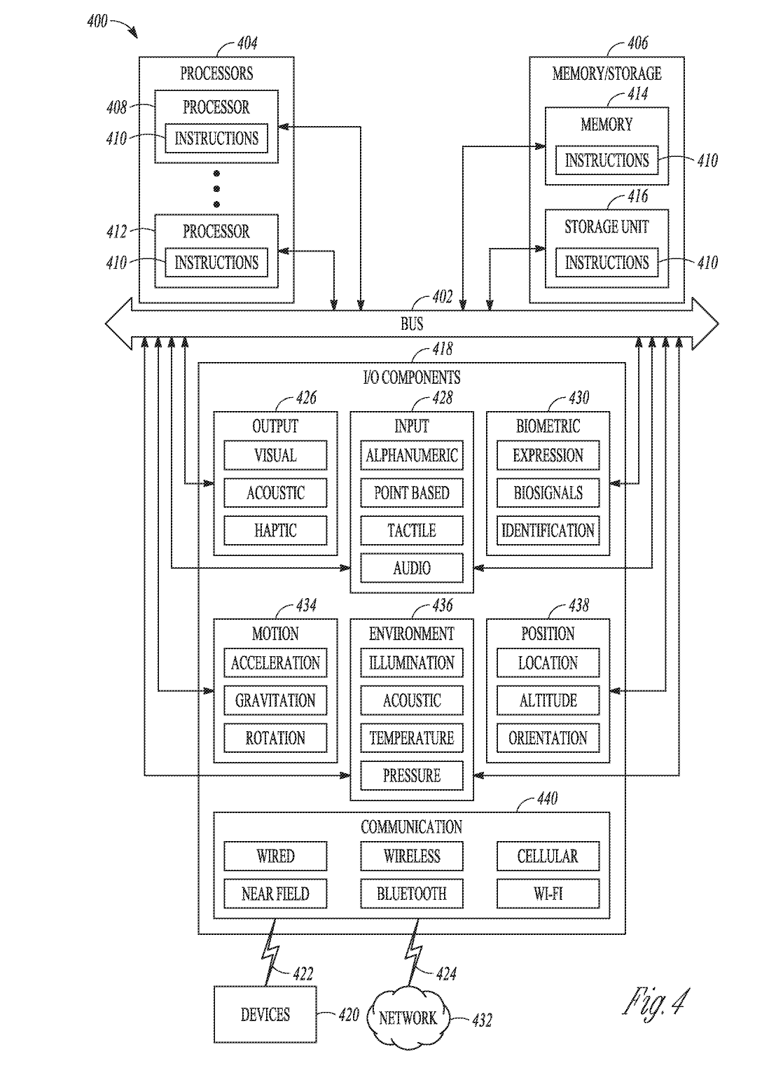

FIG. 3 is a block diagram illustrating an example software architecture 306, which may be used in conjunction with various hardware architectures herein described. FIG. 3 is a non-limiting example of a software architecture 306 and it will be appreciated that many other architectures may he implemented to facilitate the functionality described herein. The software architecture 306 may execute on hardware such as a machine 400 of FIG. 4 that includes, among other things, processors 404, memory/storage 406, and I/O components 418. A representative hardware layer 352 is illustrated and can represent, for example, the machine 400 of FIG. 4. The representative hardware layer 352 includes a processing unit 354 having associated executable instructions 304. The executable instructions 304 represent the executable instructions of the software architecture 306, including implementation of the methods, components, and so forth described herein. The hardware layer 352 also includes memory and/or storage modules as memory/storage 356, which also have the executable instructions 304. The hardware layer 352 may also comprise other hardware 358.

In the example architecture of FIG. 3, the software architecture 306 may be conceptualized as a stack of layers where each layer provides particular functionality. For example, the software architecture 306 may include layers such as an operating system 302, libraries 320, frameworks/middleware 318, applications 316, and a presentation layer 314. Operationally, the applications 316 and/or other components within the layers may invoke application programming interface (API) API calls 308 through the software stack and receive messages 312 in response to the API calls 308. The layers illustrated are representative in nature, and not all software architectures have all layers. For example, some mobile or special-purpose operating systems may not provide a frameworks/middleware 318, while others may provide such a layer. Other software architectures may include additional or different layers.

The operating system 302 may manage hardware resources and provide common services. The operating system 302 may include, for example, a kernel 322, services 324, and drivers 326. The kernel 322 may act as an abstraction layer between the hardware and the other software layers. For example, the kernel 322 may be responsible for memory management, processor management (e.g., scheduling), component management, networking, security settings, and so on. The services 324 may provide other common services for the other software layers. The drivers 326 are responsible for controlling or interfacing with the underlying hardware. For instance, the drivers 326 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 320 provide a common infrastructure that is used by the applications 316 and/or other components and/or layers. The libraries 320 provide functionality that allows other software components to perform tasks in an easier fashion than by interfacing directly with the underlying operating system 302 functionality (e.g., kernel 322, services 324, and/or drivers 326). The libraries 320 may include system libraries 344 (e.g., C standard library) that may provide functions such as memory allocation functions, string manipulation functions, mathematical functions, and the like. In addition, the libraries 320 may include API libraries 346 such as media libraries (e.g., libraries to support presentation and manipulation of various media formats such as MPEG4, H264, MP3, AAC, AMR, IPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 320 may also include a wide variety of other libraries 348 to provide many other APIs to the applications 316 and other software components/modules.

The frameworks/middleware 318 (also sometimes referred to as middleware) provide a higher-level common infrastructure that may be used by the applications 316 and/or other software components/modules. For example, the frameworks/middleware 318 may provide various graphic user interface ((QUI) functions, high-level resource management, high-level location services, and so forth. The frameworks/middleware 318 may provide a broad spectrum of other APIs that may be utilized by the applications 316 and/or other software components/modules, some of which may be specific to a particular operating system or platform.

The applications 316 include built-in applications 338 and/or third-party applications 340. Examples of representative built-in applications 338 may include, but are not limited to, a contacts application, a browser application, a book reader application, a location application, a media application, a messaging application, and/or a game application. The third-party applications 340 may include any application developed using the ANDROID™ or IOS™ software development kit (SDK) by an entity other than the vendor of the particular platform, and may be mobile software running on a mobile operating system such as IOS™, ANDROID™, WINDOWS® Phone, or other mobile operating systems. The third-party applications 340 may invoke the API calls 308 provided by the mobile operating system (such as the operating system 302) to facilitate functionality described herein.

The applications 316 may use built-in operating system functions (e.g., kernel 322, services 324, and/or drivers 326), libraries 320, and frameworks/middleware 318 to create user interfaces to interact with users of the system. Alternatively, or additionally, in some systems, interactions with a user may occur through a presentation layer, such as the presentation layer 314. In these systems, the application/component “logic” can be separated from the aspects of the application/component that interact with a user.

Some software architectures use virtual machines. In the example of FIG. 3, this is illustrated by a virtual machine 310. The virtual machine 310 creates a software environment where applications/components can execute as if they were executing on a hardware machine (such as the machine 400 of FIG. 4, for example). The virtual machine 310 is hosted by a host operating system (operating system 302 in FIG. 3) and typically, although not always, has a virtual machine monitor 360, which manages the operation of the virtual machine 310 as well as the interface with the host operating system (i.e., operating system 302). A software architecture executes within the virtual machine 310, such as an operating system (OS) 336, libraries 334, frameworks 332, applications 330, and/or a presentation layer 328. These layers of software architecture executing within the virtual machine 310 can be the same as corresponding layers previously described or may be different.

FIG. 4 is a block diagram illustrating components of a machine 400, according to some example embodiments, able to read instructions from a machine-readable medium (e.g., a machine-readable storage medium) and perform any one or more of the methodologies discussed herein. Specifically, FIG. 4 shows a diagrammatic representation of the machine 400 in the example form of a computer system, within which instructions 410 (e.g., software, a program, an application, an applet, an app, or other executable code) for causing the machine 400 to perform any one or more of the methodologies discussed herein may be executed. As such, the instructions 410 may be used to implement modules or components described herein. The instructions 410 transform the general, non-programmed machine into a particular machine programmed to carry out the specific described and illustrated functions in the manner described.

In alternative embodiments, the machine 400 operates as a standalone device or may be coupled (e.g., networked) to other machines. In a networked deployment, the machine 400 may operate in the capacity of a server machine or a client machine in a server-client network environment, or as a peer machine in a peer-to-peer (or distributed) network environment. The machine 400 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 410, sequentially or otherwise, that specify actions to be taken by the machine 400. Further, while only a single machine 400 is illustrated, the term “machine” shall also be taken to include a collection of machines that individually or jointly execute the instructions 410 to perform any one or more of the methodologies discussed herein.

The machine 400 may include processors 404, memory/storage 406, and I/O components 418, which may be configured to communicate with each other such as via a bus 402. The memory/storage 406 may include a memory 414, such as a main memory, or other memory storage, and a storage unit 416, both accessible to the processors 404 such as via the bus 402. The storage unit 416 and memory 414 store the instructions 410 embodying any one or more of the methodologies or functions described herein. The instructions 410 may also reside, completely or partially, within the memory 414, within the storage unit 416, within at least one of the processors 404 (e.g., within the processor's cache memory), or any suitable combination thereof, during execution thereof by the machine 400. Accordingly, the memory 414, the storage unit 416, and the memory of the processors 404 are examples of machine-readable media.

The I/O components 418 may include a wide variety of components to receive input, provide output, produce output, transmit information, exchange information, capture measurements, and so on. The specific I/O components 418 that are included in a particular machine will depend on the type of machine. For example, portable machines such as mobile phones will likely include a touch input device or other such input mechanisms, while a headless server machine will likely not include such a touch input device. It will be appreciated that the I/O components 418 may include many other components that are not shown in FIG. 4. The I/O components 418 are grouped according to functionality merely for simplifying the following discussion and the grouping is in no way limiting. In various example embodiments, the I/O components 418 may include output components 426 and input components 428. The output components 426 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 428 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 418 may include biometric components 430, motion components 434, environment components 436, or position components 438 among a wide array of other components. For example, the biometric components 430 may include components to detect expressions (e.g., hand expressions, facial expressions, vocal expressions, body gestures, or eye tracking), measure bio signals (e.g., blood pressure, heart rate, body temperature, perspiration, or brain waves), identify a person (e.g., voice identification, retinal identification, facial identification, fingerprint identification, or electroencephalogram-based identification), and the like. The motion components 434 may include acceleration sensor components (e.g., accelerometer), gravitation sensor components, rotation sensor components (e.g., gyroscope), and so forth. The environment components 436 may include, for example, illumination sensor components (e.g., photometer), temperature sensor components (e.g., one or more thermometers that detect ambient temperature humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 438 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 418 may include communication components 440 operable to couple the machine 400 to a network 432 or devices 420 via a coupling 424 and a coupling 422 respectively. For example, the communication components 440 may include a network interface component or another suitable device to interface with the network 432. In further examples, the communication components 440 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 420 may be another machine or any of a wide variety of peripheral devices (e.g., a peripheral device coupled via a USB).

Moreover, the communication components 440 may detect identifier; or include components operable to detect identifiers. For example, the communication components 440 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 440, such as location via Internet Protocol (IP) geolocation, location via Wi-Fi® signal triangulation, location via detecting an NFC beacon signal that may indicate a particular location, and so forth.

In this example, the systems and methods are described in the general context of computer program instructions executed by one or more computing devices that can take the form of a traditional server/desktop/laptop; mobile device such as a smartphone or tablet; etc. Computing devices typically include one or more processors coupled to data storage for computer program modules and data. Key technologies include, but are not limited to, the multi-industry standards of Microsoft and Linux/Unix based Operating Systems; databases such as SQL Server, Oracle, NOSQL, and DB2; Business Analytic/Intelligence tools such as SPSS, Cognos, SAS, etc.; development tools such as Java, .NET Framework (VB.NET, ASP.NET, AJAX.NET, etc.); and other e-commerce products, computer languages, and development tools. Such program modules generally include computer program instructions such as routines, programs, objects, components, etc., for execution by the one or more processors to perform particular tasks, utilize data, data structures, and/or implement particular abstract data types. While the systems, methods, and apparatus are described in the foregoing context, acts and operations described hereinafter may also be implemented in hardware.

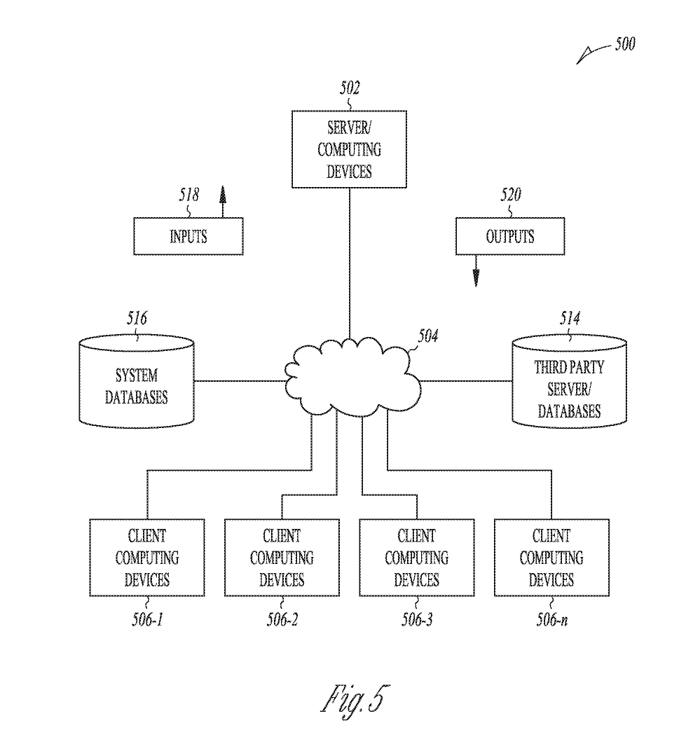

FIG. 5 shows a block diagram of another exemplary system 500 for management of an advertising exchange using email data according to one embodiment. In this exemplary implementation, system 500 may include one or more servers/computing devices 502 (e.g., server 1, server 2, . . . , server n) operatively coupled over network 504 to one or more client computing devices 506-1 to 506-n, which may include one or more consumer computing devices, one or more provider computing devices, one or more remote access devices, etc. The one or more servers/computing devices 502 may also be operatively connected, such as over a network 504, to one or more third-party servers/databases 514 (e.g., database 1, database 2, . . . , database n). The one or more servers/computing devices 502 may also be operatively connected, such as over a network 504, to one or more system databases 516 (e.g., database 1, database 2, . . . , database n). Various devices may be connected to the system 500, including, but not limited to, client computing devices, consumer computing devices, provider computing devices, remote access devices, etc. The system 500 may receive inputs 518 and outputs 520 from the various computing devices, servers and databases.

Server/computing device 502 may represent, for example, any one or more of a server, a general-purpose computing device such as a server, a personal computer (PC), a laptop, a smart phone, a tablet, and/or so on. Networks 504 represent, for example, any combination of the Internet, local area network(s) such as an intranet, wide area network(s), cellular networks, WiFi networks, and/or so on. Such networking environments are commonplace in offices, enterprise-wide computer networks, etc. Client computing devices 506, which may include at least one processor, represent a set of arbitrary computing devices executing application(s) that respectively send data inputs to server/computing device 502 and/or receive data outputs from server/computing device 502. Such computing devices include, for example, one or more of desktop computers, laptops, mobile computing devices (e.g., tablets, smart phones, human-wearable device), server computers, and/or so on. In this implementation, the input data comprises, for example, real-time campaign data, audience profile, attribution data, and/or so on, for processing with server/computing device 502. In one implementation, the data outputs include, for example, emails, templates, forms, and/or so on. Embodiments of the present disclosure may also be used for collaborative projects with multiple users logging in and performing various operations on a data project from various locations. Embodiments of the present disclosure may be web-based, smart phone-based and/or tablet-based or human-wearable device based.

In this exemplary implementation,server/computing device 502 includes at least one processor coupled to a system memory. System memory may include computer program modules and program data.

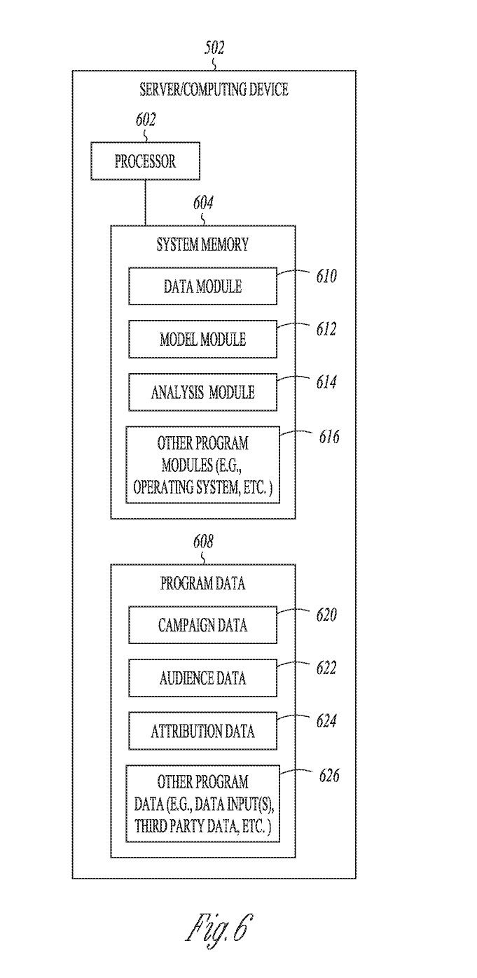

In this exemplary implementation, server/computing device 502 includes at least one processor 602 coupled to a system memory 604, as shown by the block diagram in FIG. 6. System memory 604 may include computer program modules 606 and program data 608. In this implementation program modules 606 may include data module 610, model module 612, analysis module 614, and other program modules 616 such as an operating system, device drivers, etc. Each module 610 through 616 may include a respective set of computer-program instructions executable by processor(s) 602. This is one example of a set of program modules, and other numbers and arrangements of program modules are contemplated as a function of the particular arbitrary design and/or architecture of server/computing device 502 and/or system 500 (FIG. 5). Additionally, although shown on a single server/computing device 502, the operations associated with respective computer-program instructions in the program modules 606 could be distributed across multiple computing devices. Program data 608 may include campaign data 620, audience data 622, attribution data 624, and other program data 626 such as data input(s), third-party data, and/or others.

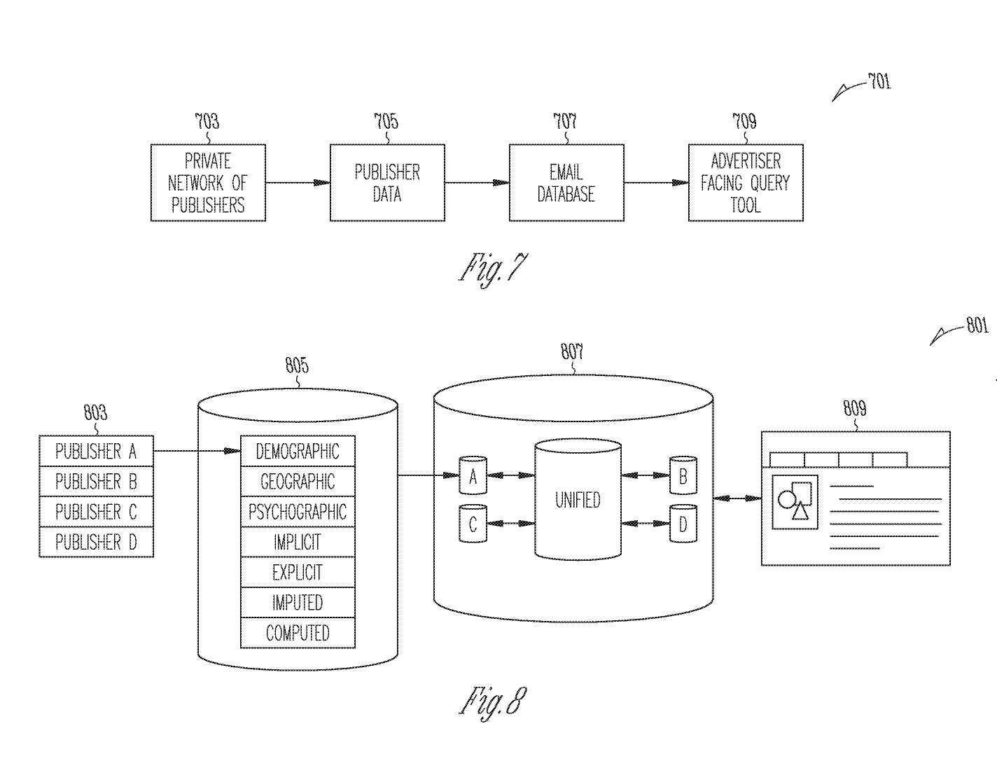

As shown in FIG. 7, certain embodiments may provide management of data in an email channel.

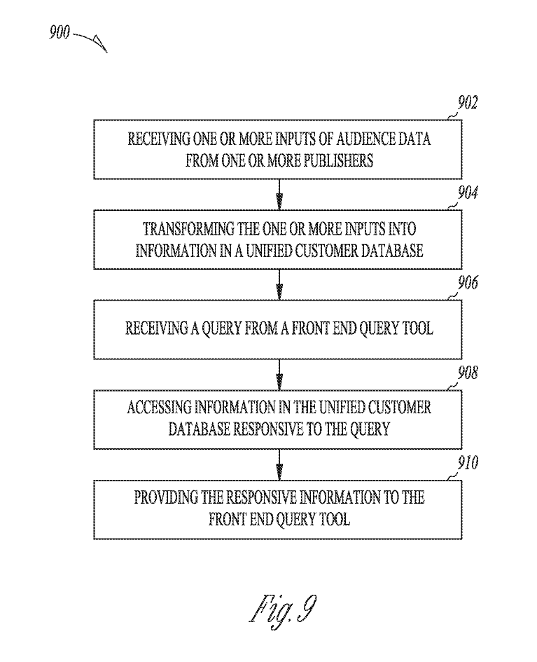

A system 701 may aggregate data from one or more publishers into a unified database. A network of publishers 703 may be provided and/or accessible. In certain embodiments, the network of publishers 703 may be a private network of publishers. Each of the publishers 703, such as Publisher A, (FIG. 8) may include audience data. The audience data for each publisher 703 may be transformed and aligned into a unified email database 707. An advertiser facing query tool 709 may interact with the unified email database 707 to provide advertisers with requested information. Data may be accessed from and/or provided by one or more sources.

FIG. 8 shows an exemplary flow diagram in a system 801 for management of data in an email channel.

The system 801 may aggregate data from one or more publishers into a unified database. A network of publishers 803 may be provided and/or accessible. In certain embodiments, the network of publishers 803 may be a private network of publishers. Publishers A D are shown in FIG. 8 for illustrative purposes, but it is understood that any number of publishers may be provided in the network of publishers 803. Private networks of publishers may be maintained for the purpose of fulfilling advertiser media buys.

Each of the publishers 803, such as Publisher A, may include audience data stored in a database 805. Audience data may include individual and household-level demographics from self-reported sources and third-party vendors, digital shopping behavior across other marketing campaigns, and offline shopping behavior sourced from catalogues, loyalty cards, retail stores, etc. Audience data may include one or more of the following:
demographics (explicit information on the email record such as, but not limited to, age, gender, income, marital status, etc.);
geographic (explicit information on the email record such as, but not limited to, postal address, zip code, state, etc.);
psychographic (description of personality, values, opinions, attitudes, interests, lifestyles, etc., that allow advertisers to customize content to improve response);
implicit: Any third party data, not necessarily questionable as to its truth, but the audit trail is less strict/complete;
explicit: Data that is verified or observed, which may also include self-reported data;
imputed: Use of statistics to determine a value that is missing from a data set. This may be used as a placeholder until explicit information is received. For example, based on response history, a person's gender may be determined, but there may not be explicit or implicit data confirming the person's gender.; and
computed: Data, such as, but not limited to, response rate, which are based on observed/verified information. For example, the number of times an individual opens, out of the number of times they receive, an email. In certain embodiments, raw transactions that represent a purchase history may be used to compute a score such as RFM (recency, frequency, monetary), which would not typically be reported.

The audience data for each publisher may be transformed and aligned into a unified email database 807. Publishers may provide records with audience attributes. As such, publishers may provide records with the same types of information, but not always all of the same types of information. Publisher records may be transformed into a common format with a set of cleaning and augmentation procedures applied, such as, but not limited to, filling in gaps, layering on new information, etc. Publishers can pass data in any format, which may be independent of the destination format. As such, the transforming may include normalizing the audience data, converting the audience data to a predetermined format, inputting missing values, appending additional information, cleansing, and manipulating the data for querying in a unified customer database. Each of the publisher records may be stored separately in the email database 807 and/or may be merged into a single database.

An advertiser facing, or front-end, query tool 809 may interact with the unified email database 807 to provide advertisers with requested information. Data may be accessed from and/or provided by one or more sources. The front-end query tool 809 may allow advertisers to count available email inventory across the publisher email database.

Thus, in some examples, there is provided a system for management of an advertising exchange using email data, the system comprising one or more databases comprising one or more inputs and one or more processors for receiving one or more inputs of audience data from one or more publishers; transforming the one or more inputs into information in a unified customer database; receiving a query from a front-end query tool; accessing information in the unified customer database responsive to the query; and providing the responsive information to the front-end query tool.

In some examples, the one or more publishers may include a network of multiple publishers. The audience data may be selected from the group consisting of: demographics, geographic, psychographic, implicit, explicit, imputed, computed, and combinations thereof. In some examples, the transforming the one of more inputs may comprise normalizing the audience data, converting the audience data to a predetermined format, inputting missing values, appending additional information, cleansing, and manipulating the data for querying in a unified customer database. The unified customer database may comprise a series of databases for each of the one or more publishers. The query may be from an advertiser, and in some examples the responsive information may include a count of available email inventory.

In further aspects of the present disclosure, methods of management of an advertising exchange using email data are provided. An example flow chart for one such method 900 is shown in FIG. 9. The method 900 may include, at operation 902, receiving one or more inputs of audience data from one or more publishers (e.g., publishers 703, 803); at operation 904, transforming the one or more inputs into information in a unified customer database (e.g. unified database 707); at operation 906, receiving a query from a front-end query tool e.g., the front-end query tool 709); at operation 908, accessing information in the unified customer database responsive to the query; and, at operation 910, providing the responsive information to the front-end query tool.

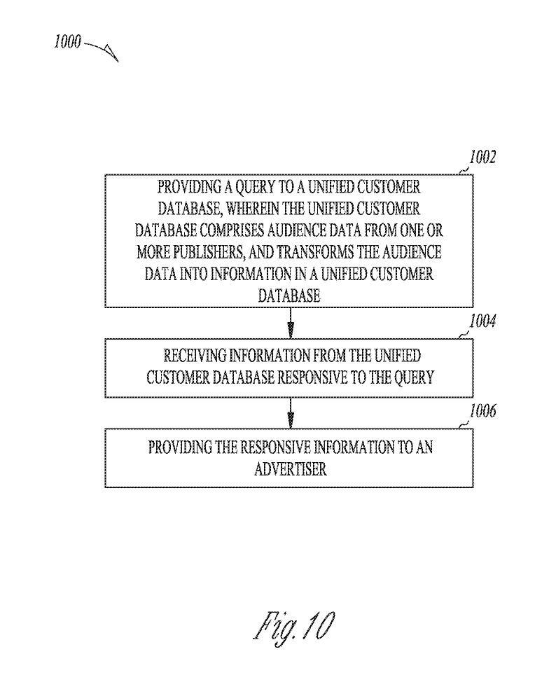

An example flow chart of another method of management f an advertising exchange using email data is shown in FIG. 10. The method 1000 may include, at operation 1002, providing a query to a unified customer database, wherein the unified customer database comprises audience data from one or more publishers, and transforms the audience data into information in a unified customer database; at operation 1004, receiving information from the unified customer database responsive to the query; and, at operation 1006, providing the responsive information to an advertiser.

In some examples, a non-transitory machine-readable medium includes instructions that, when read by a machine, cause the machine to perform operations comprising at least the non-limiting example operations summarized above with reference to FIGS. 9 and 10, and described more generally herein with reference to the accompanying figures.

Although the subject matter has been described with reference to some specific example embodiments, it will be evident that various modifications and changes may be made to these embodiments without departing from the broader spirit and scope of the disclosed subject matter. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Description, therefore, is not to be taken in a limiting sense, and the scope of various embodiments is defined only by any appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computerized method of management of an advertising exchange using email data, the computerized method comprising the steps of:
receiving one or more inputs of audience data from one or more publishers;
transforming the one or more inputs into information in a unified customer database;
receiving a query from a front end query tool;
accessing information in the unified customer database responsive to the query; and
providing the responsive information to the front end query tool.

2. The method of claim 1, wherein the one or more publishers is a network of multiple publishers.

3. The method of claim 1, wherein the audience data is selected from a group consisting of: demographics, geographic, psychographic, implicit, explicit, imputed, computed, and combinations thereof.

4. The method of claim 1, wherein the transforming comprises normalizing the audience data, converting the audience data to a predetermined format, inputting missing values, appending additional information, cleansing, and manipulating the audience data for querying in the unified customer database.

5. The method of claim 1, wherein the unified customer database comprises a series of databases for each of the one or more publishers.

6. The method of claim 1, wherein the query is from an advertiser.

7. The method of claim 1, wherein the responsive information is a count of available email inventory.

8. A computerized method of management of an advertising exchange using email data, the computerized method comprising the steps of:
providing a query to a unified customer database, wherein the unified customer database comprises audience data from one or more publishers, and transforms the audience data into information in the unified customer database;
receiving information from the unified customer database responsive to the query; and
providing the responsive information to an advertiser.

9. The method of claim 8, wherein the one or more publishers is a network of multiple publishers.

10. The method of claim 8, wherein the audience data is selected from a group consisting of: demographics, geographic, psychographic, implicit, explicit, imputed, computed, and combinations thereof.

11. The method of claim 8, wherein the transforming comprises normalizing the audience data, converting the audience data to a predetermined format, inputting missing values, appending additional information, cleansing, and manipulating the data for querying in the unified customer database.

12. The method of claim 8, wherein the unified customer database comprises a series of databases for each of the one or more publishers.

13. The method of claim 8, wherein the query is from the advertiser.

14. The method of claim 8, wherein the responsive information is a count of available email inventory.

15. A system for management of an advertising exchange using email data, the system comprising:
one or more databases comprising one or more inputs; and
one or more processors for:
receiving one or more inputs of audience data from one or more publishers;
transforming the one or more inputs into information in a unified customer database;
receiving a query from a front end query tool;
accessing information in the unified customer database responsive to the query; and
providing the responsive information to the front end query tool.

16. The system of claim 15, wherein the one or more publishers is a network of multiple publishers.

17. The system of claim 15, wherein the audience data is selected from a group of data consisting of: demographic data, geographic data, psychographic data, implicit data, explicit data, imputed data, computed data, and combinations thereof.

18. The system of claim 15, wherein the transforming comprises normalizing the audience data, converting the audience data to a predetermined format, inputting missing values, appending additional information, cleansing, and manipulating the data for querying in the unified customer database.

19. The system of claim 15, wherein the unified customer database comprises a series of databases for each of the one or more publishers.

20. The system of claim 15, wherein the query is from an advertiser.

21. The system of claim 15, wherein the responsive information is a count of available email inventory.

22. A non-transitory machine-readable medium containing instructions which, when read by a machine, cause the machine to perform operations comprising, at least:
receiving one or more inputs of audience data from one or more publishers;
transforming the one or more inputs into information in a unified customer database;
receiving a query from a front end query tool;
accessing information in the unified customer database responsive to the query; and
providing the responsive information to the front end query tool.

23. A non-transitory machine-readable medium containing instructions which, when read by a machine, cause the machine to perform operations comprising, at least:
providing a query to a unified customer database, wherein the unified customer database comprises audience data from one or more publishers, and transforms the audience data into information in the unified customer database;
receiving information from the unified customer database responsive to the query; and
providing the responsive information to an advertiser.
